(19) United States
(12) Patent Application Publication
(10) Pub. No.: US 2016/0086194 A1
(43) Pub. Date: Mar. 24, 2016

(54) METHOD, APPARATUS AND SYSTEM FOR PROVIDING A SECURE AND USER IDENTIFIABLE SERVICE SIGNATURE

(71) Applicant: Verizon Patent and Licensing Inc., Arlington, VA (US)

(72) Inventors: Avinash S. CHUGH, Nashua, NH (US); Jae Won CHUNG, Lexington, MA (US); Damascene M. JOACHIMPILLAI, Westford, MA (US); Manian KRISHNAMOORTHY, Hyannis, MA (US)

(21) Appl. No.: 14/495,476

(22) Filed: Sep. 24, 2014

(51) Int. Cl. G06Q 30/00

(52) U.S. Cl. CPC G06Q 30/0185

(57) ABSTRACT

An approach is provide for creating a secure and user-identifiable service signature. The approach involves creating a signature associated with a service, wherein the service is provided by a service provider to a user in conjunction with another party, and wherein the signature is personalized to the user. The approach also involves presenting the signature to the user via a device receiving a delivery, a link for initiating the delivery, or a combination thereof of the service to the user.

### BACKGROUND

Service and content providers, and device manufacturers (e.g., wireless, cellular, etc.) are continually challenged to deliver value and convenience to users and consumers by, for example, providing compelling network services. One area of interest has been the development of services (e.g., business-to-business-to-customer (B2B2C) services) that can be repackaged from one service provider to another service provider (or other third party) before being delivered to the end consumer. For example, one service provider (e.g., a wireless carrier) can provide a B2B2C sponsored bandwidth service that can be used to deliver content from another provider (e.g., a web content or services provider) by redirecting bandwidth charges related to delivering the content from the consumer to the web content or services provider. However, from the consumer point of view, it may be difficult for the user to determine when such B2B2C services are active, and then to determine whether the service is legitimate and has not been fraudulently spoofed.

Accordingly, there is a need for providing secure and user-identifiable service signatures to help end consumers to identify when B2B2C services are being used and whether the signature is legitimate.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system for providing a secure, user-identifiable service signature and indicators, according to one embodiment;

FIG. 2 is a diagram of the components of a service signature and indicator platform, according to one embodiment;

FIG. 3 is a flowchart of processes for providing a secure, user-identifiable service signature, according to one embodiment;

FIG. 4 is a flowchart of processes for providing a secure, user-identifiable service signature and indicators, according to another embodiment;

FIG. 5 is a flowchart of processes for initiating the creating and presenting a signature for providing a secure, user-identifiable service signature, according to one embodiment;

FIGS. 6A-6C are diagrams of user interfaces, according to various embodiments;

FIG. 7 is a diagram of events involving of a system for providing a secure, user-identifiable service signature and indicators, according to one embodiment;

FIG. 8 is a diagram of a computer system that can be used to implement various exemplary embodiments; and

FIG. 9 is a diagram of a chip set that can be used to implement an embodiment of the invention.

### DESCRIPTION OF SOME EMBODIMENTS

A preferred method, apparatus and system for providing secure and user-identifiable service signatures are herein provided. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

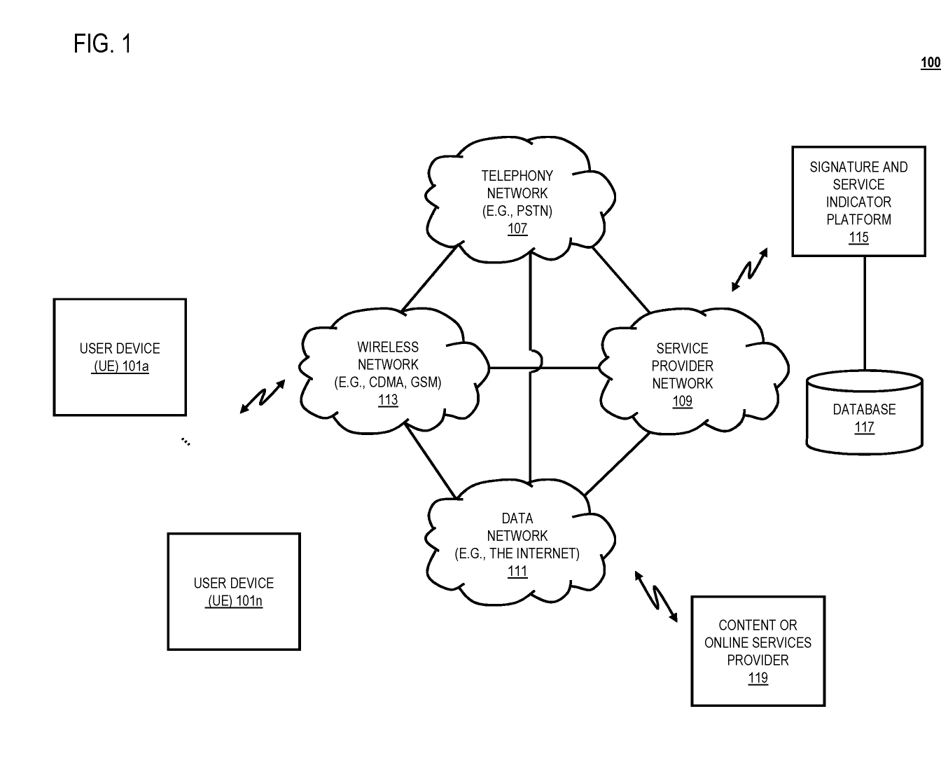

FIG. 1 is a diagram of a system for providing a secure, user-identifiable service signature and indicators, according to one embodiment. As the complexity services available to consumers increases, it is becoming increasingly difficult or otherwise inefficient for a single service provide to provide all functionality associated to a service to end users. Accordingly, service providers are increasingly providing underlying services to other providers for final delivery to consumers. For example, as previously discussed, service providers may provide sponsored data services so that other content providers/retailers (e.g., online shopping websites) can provide free data bandwidth when consumers are accessing content from the providers or retailers. In another example, a service provider may provide e-commerce checkout services (e.g., virtual shopping cart management, payment processing services, etc.) that are used by other providers to service their customers.

In many cases, such underlying services can be an incentive for a consumer to select one service provider/retailer over another. As a result, services delivered on behalf of, or in conjunction with other parties (content providers, enterprises, etc.,) to the user, such as in a business-to-business-to-customer scenario (B2B2C), traditionally can be frequent targets of spoofing attacks. For example, content providers may contract with wireless carriers to provide sponsored data services and advertise this fact to consumers. However, other providers who may not provide the same sponsored data services may also fraudulently advertise that they also provide sponsored data service with hopes of illicitly enticing users to click on their services. This can result in a frustrating experience for the end user and discourage users from using such underlying B2B2C services.

In one embodiment, to prevent fraud and/or spoofing, a visual notification or indicator can be presented to a user to indicate when the B2B2C service active. This visual notification, for instance, can be an important user experience element for service that may be delivered based on dynamic parameters such as time, location, etc. Because the user may often rely solely on the visual notification to determine if a service is being delivered and/or whether the service being delivered is fraudulent, service providers face significant technical challenges to make sure such notifications are secure and robust.

To address this problem, system 100 of FIG. 1 introduces a capability to personalize service notifications as service signatures that are shared between an originating service provider and the user without exposure to any other parties (e.g., content providers, enterprises, other service providers, etc.) in a B2B2C scenario. More specifically, in one embodiment, a service provider creates a unique signature for each user. By way of example, the creation of the unique signature may be performed by either the service provider or the user. The service provider then communicates the unique signature to the user via one or more communication methods such as text messaging, email, etc. In one embodiment, upon delivery of a B2B2C service to the user, the service provider includes the unique signature as part of or in conjunction with a service indicator (e.g., visual notification+signature). In this way, the unique signature confirms that the service indicator is legitimate, and not spoofed by a fraudulent content provider or other party.

As shown in FIG. 1, in one embodiment, system 100 includes at least one user device 101a-101n, a telephony network 107, a service provider network 109, a data network 111, a wireless network 113, a signature and service indicator platform 115, a database 117, and a content or online service provider 119.

In one embodiment, the signature and service indicator platform 115 is operated by service provider delivering B2B2C services via the system 100. In one embodiment, the signature and service indicator platform 115 interacts with the user devices 101 via known commands and functions of a native operating system (OS) or other protocol operating within the system 100. For example, the user devices 101 may be any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), smartphone or any combination thereof. In addition, the user device 101 may execute different operating systems (OS).

In one embodiment, the signature and service indicator platform 115 may include or be associated with at least one database 117 for storing user signature and related data, a content or online service provider 119 that offers a B2B2C service provided by a service provider (e.g., a carrier) associated with the platform 115, or a combination thereof. It is also contemplated that signature and service indicator platform 115 has access to database 117 through, telephony network 107, service provider network 109, data network 111, and/or wireless network 113.

In certain embodiments, the user devices 101a-101n, the signature and service indicator platform 115, sensors 105a-105n, and other elements of system 100 may be configured to communicate via a service provider network 109. According to certain embodiments, one or more networks, such as data network 111, telephony network 107, and/or wireless network 113, can interact with the service provider network 109. Networks 107-113 may be any suitable wireline and/or wireless network, and be managed by one or more service providers. For example, telephony network 107 may include a circuit-switched network, such as the public switched telephone network (PSTN), an integrated services digital network (ISDN), a private branch exchange (PBX), or other like network.

Telephony Network 107, Service Provider Network 109, Data Network 111, Wireless Network 113 may employ various technologies for enabling wireless communication including, for example, code division multiple access (CDMA), long term evolution (LTE), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 111 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Still further, the communication provider network may embody circuit-switched and/or packet-switched networks that include facilities to provide for transport of circuit-switched and/or packet-based communications. It is further contemplated that networks 107-113 may include components and facilities to provide for signaling and/or bearer communications between the various components or facilities of system 100. In this manner, the communication network may embody or include portions of a signaling system 7 (SS7) network, Internet protocol multimedia subsystem (IMS), or other suitable infrastructure to support control and signaling functions.

In one embodiment, signature and service indicator platform 115 is capable of creating a signature personalized to the user in order to minimize service spoofing. The platform is also capable of presenting the signature to the user via a device that receives a delivery, via a device that receives a service or a link for initiating a delivery of the service, or a combination thereof. In one embodiment, the personalized signature may be associated with a service delivered within a B2B2C environment. By way of example, a personalized signature can enhance security of the service against parties attempting to spoof the services by, for instance, keeping the personalized signature secret between the originating service provider (e.g., a service provider operating the platform 115) to avoid spoofing of the signature while allowing the user to validate the personalized signature using the unique features (e.g., unique visual features) known to the user.

In one embodiment, the creation of the signature can be associated with a service so that when the service is initiated, the signature can be created (e.g., by either the service provider or the user). It is also contemplated that other events specified by the service provider and/or the user may trigger the creation of a personalized signature. For example, in the context of a sponsored data service between a communications carrier (e.g., a service provider) and a user who is a subscriber to the carrier, the carrier may ask the user create a personalized signature when signing up for general service with the carrier. Alternatively, the carrier can ask the user to create the signature when the user first engages in a network activity that relies on sponsored data (e.g., data provided by the carrier for user that is to be paid for by another party such as a content provider). It is noted that although various embodiments are discussed with respect to a sponsored data service as an example of a B2B2C service, it is contemplated that the approaches of the various embodiments described herein are applicable to any type of service delivered in a B2B2C environment, with any number of participating parties intervening between the originating service provider and the user.

In one embodiment, the signature and service indicator platform 115 is capable of creating the signature directly between the originating service provider (e.g., the carrier in the example above) and the user. Accordingly, the signature will be unknown by other parties (e.g., the content provider, enterprise, etc.) participating in the B2B2C environment and may be delivered directly by the carrier to the user. By way of example, the direct interaction between the service provider and the user enables the system 100 to provide an increased level of security of the service by potentially unnecessary exposure of the personalized signatures to the other participating parties.

In one embodiment, the personalized signature may be delivered or otherwise presented to the user when the other party initiates or triggers delivery of a B2B2C service to the user. By way of example, delivery of the personalized signature can occur as a plugin component embedded with the content, services, etc. delivered by the other participating parties to the user. For example, in the context of a sponsored data service, the content provider may include a component (e.g., a JavaScript component) that obtains the personalized signature directly from the platform 115 to embed in the content stream sent to the user, without requiring the service provider to obtain and store the personalized signature on the content provider's systems or databases. In this way, the integrity and security of personalized signature is maintained.

In another embodiment, the signature and service indicator platform 115 is capable of delivering the signature to the user prior to delivery of any associated service to the user. This enables, for instance, the user to be informed of his/her personalized signature before engaging in any service or content. In one embodiment, the user may be informed via any communication method supported by the system 100 and/or the networks 107-113 (e.g., email, text message, etc.) of his/her personalized signature. In one embodiment, pre-delivery of the personalized signature enables a user to check whether the correct signature is being presented when using or deciding to user an associated B2B2C service. In one embodiment, the signature and service indicator platform 115 is capable of confirming acknowledgement of receipt of the signature by the user by e.g. requesting acknowledgement via a communication method (e.g., email, SMS, etc.). In addition, the signature and service indicator platform 115 may provide means for the user to recover or reset personalized signatures that have been lost or remain unacknowledged.

In one embodiment, it is also contemplated that the signature might be created upon the user's own request, in which case, the user may be able to create his/her personalized signature through a user interface. In addition, the platform 115 can inform the user about the registration status the personalized signature in the system. In one embodiment, the registration status may transmitted via any communication method supported by the system 100 and/or networks 107-113 (e.g. email, text message, etc.).

In one embodiment, the signature and service indicator platform 115 supports personalized signatures of varying complexity (e.g., depending on the level of security and/or ease of use selected by the user or the service provider). For example, the user can create an easy-to-remember signature in case he/she finds that he/she does not need a highly complex signature or may instead create a more complex signature that can be harder to spoof or guess.

Although various embodiments discuss the personalized signature as a visual notification, indicator, or signature, it is contemplated that the signature may use any media or mode of interaction or combination including, e.g., audio notification, haptic notification, and/or the like.

In one embodiment, the request to create a personalized signature may also be based on a request from the service provider, or from the service provider in combination with the user. In another embodiment, the content provider or other participating party may trigger creation of the signature.

In yet another embodiment, the platform 115 may be able to present the signature in association or in conjunction with any other service indicator or signature. By way of example, a service indicator may be non-personalized visual symbol or other indicator that indicates that a B2B2C service or other service is active. In some embodiments, the service indicator can indicator other information such as whether the service is a sponsored data service, how the service is sponsored, the speed of the service, time it will take for the service to be completed, whether the service is trustworthy, whether the service has been scanned for virus, etc. In one embodiment, the service indicator can be separate and distinct from the personalized signature. In other embodiments, the service indicator may be combined with the personalized signature (e.g., by overlapping, layering, etc.). In yet other embodiments, the personalized signature itself make take the place of the service indicator.

In an example use case where the B2B2C service is a sponsored data service, a content provider may sponsor the data service or part of the data service for providing content so users that who access the content (e.g., through their mobile application) will not be charged for the data used for accessing the content. In this case, an icon may be presented (e.g., via a plug-in embedded in the content) to present a service indicator to indicate that the user will not be charged. By way of example, the service indicator may be an icon or symbol, and may also be used to indicate different types of services and/or to covey different types of information. For instance, a symbol with the number five besides a crossed dollar sign may indicate to the user that access to the service is sponsored for the first 5 times that the user access the service, after which the user will be charged for any data utilized for that service. It is contemplated that a glossary explaining the meaning of the symbols for service indicators may be provided to the user, or that the meaning of the symbol may be provided to the user when e.g. the user clicks on a symbol.

In this example use case, an account or billing arrangement is established between the service provider (e.g., carrier providing the data bandwidth for carrying the content) and the end user. The content provider is an intervening party in a B2B2C environment that acts to deflect the cost to the user of using the service provider's bandwidth as part of the sponsored data service. Accordingly, the content provider need not have knowledge of any account information or details between the service provider and the user, including, e.g., any preconfigured service signature or indicator. Moreover, by having the carrier present the service signatures and/or indicators associated with the B2B2C service directly, the security and integrity of the user's personalized signatures can be more securely and robustly maintained by limiting the potential exposure of this data to avoid potential spoofing risks. In other words, the risk that a fraudulent party (e.g., a fraudulent content provider) can spoof the user's personalized signature and/or indicator can be significantly diminished, as usually the carrier has this information, while the content provider, enterprise, etc. will not.

As noted above, in one embodiment, the signature and service indicator platform 115 is capable of initiating the presentation of the signature to the user via a plug-in component that is embedded into the content or service provider by another party (e.g., a content provider, enterprise, etc.). By way of example, this plug-in component may be a JavaScript component. In addition or alternatively, the component may be coded in any other standard programming language, script, protocol, etc., and/or implemented in any embeddable object, library, application programming interface, etc. In one embodiment, the embedded code or object in the content enables a direct query or retrieval of a user's personalized signature from the underlying service provider's systems (e.g., the platform 115) without intervention from the content provider whose content includes the plug in. Accordingly, the content provider, enterprise, etc. is not required to take any additional step other than to embed the plug in or other embeddable object into its content to implement the personalized signature as discussed with respect to the various embodiments described herein.

Although various embodiments are described with respect to receiving a signature with an online service, content, etc., it is contemplated that the signature may be presented prior to performance or delivery of any web service or receipt of any content. In one embodiment, the signature may be presented at the time that a link for initiating a performance of a service or delivery of content is presented to the user. For example, after a web search for a service, the link to the service is presented to the user. At this time, the user's personalized signature and/or service indicator can be presented in conjunction with the link to alert the user that a B2B2C (e.g., a sponsored data service) is legitimately available for the link should the user decide to select the link and engage the service. In this way, if the search results includes results from several potential content providers, the user may be more likely to select the service from the content provider who can offer a value added B2B2C service (e.g., sponsored data service). The personalized signature accompanying the link to that service can serve as a form assurance that the associated service is likely to be legitimate.

It is noted that although various embodiments are discussed with respect to a B2B2C environment that includes a services provider as a first business, a content provider/enterprise as a second business, and a user as the customer, it is contemplated that the approaches of the various embodiments described here are applicable to a B2B2C environment that includes any number of intervening businesses. For example, applicable B2B2C environments may include any number of business layers or entities involved in delivering a service to a customer. At each layer or hierarchy of this B2B2C chain, each participating business or entity may create and present its own respective personalized signature or service indicator to the user independently from all other businesses/entities in the environment.

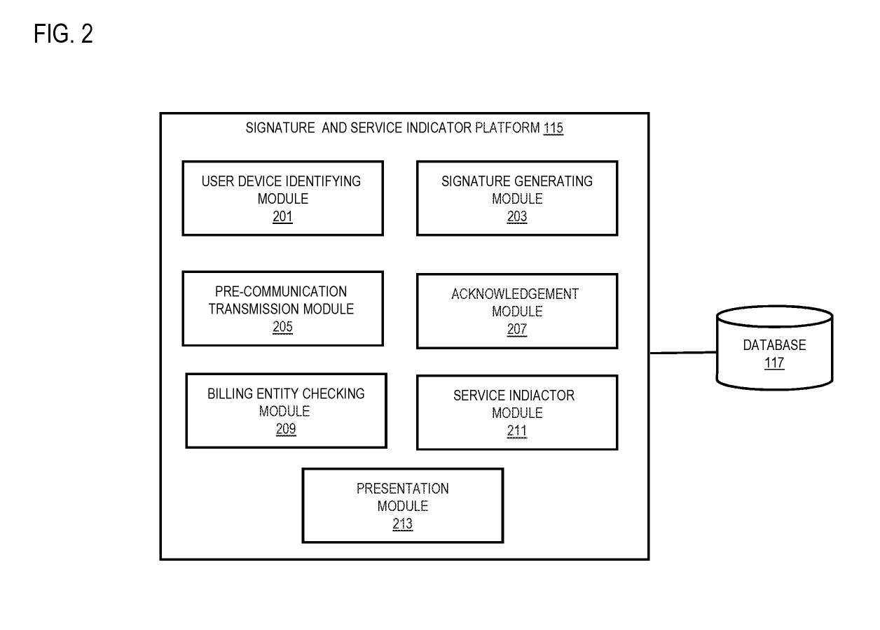

FIG. 2 is a diagram of the components of a service signature and indicators platform, according to one embodiment. In one embodiment, the signature and service indicator platform 115 includes a user device identifying module 201, a signature generating module 203, a pre-communication transmission module 205, an acknowledgement module 207, a billing entity checking module 209, a service indicator module 211, and a presentation module 213. It is contemplated that the functions of these components may be combined in one or more components or performed by other components of equivalent functionality.

In one embodiment, the user device identifying module 201 may be configured to identify and authenticate the user or user device 101 for interaction with the signature and service indicator platform 115 (e.g. if the user wishes to change his/her signature, or simply choose a signature for registration). Authentication may occur based, at least in part, on processing of a specified authentication credential, password, key or the like. As such, the user device identifying module 201 may allow or prohibit execution of the signature generating procedure, or a signature registration procedure, as performed by the signature generating module 203. It is contemplated that the user devices identifying module 201 may identify the user device and subsequently trigger the signature generating module 203, without having to authenticate the user or user device 101 (for instance, in case the user is requesting the system to generate a signature for the first time). In one embodiment, the service indicator module 211 may also be triggered by the user device identifying module 201 to initiate collecting, checking, processing, analyzing service indicator data, or any combination thereof.

In one embodiment, the Signature generating module 203 may be configured to generate a personalized signature for each user or user device 101. It is also contemplated that the signature generating module 203 may be configured to register a signature, e.g. a signature chosen by the user. The user might choose a signature by inserting the signature using a user interface and, subsequently, requesting registration of this signature. By way of example, the signature may be created using any means including, but not limited to, creating based on free-form input, selecting from a set of available signatures, automatically generating a personalized signature for confirmation by the user, etc.

In one embodiment, the pre-communication transmission module 205 may be configured to transmit the signature generated by signature generating module 203 to the user. This allows the user to know the signature so when navigating or searching for B2B2C services he/she will be able to check if the signature shown (e.g., in the web browser) is correct. An acknowledgement request may be sent to the user via a communication method such as an email, text message, etc. by acknowledgement module 207 after the pre-communication transmission module 205 sent the signature to the user.

In one embodiment, the acknowledgement module 207 may be configured to at least send and process requests for acknowledgement and to at least receive and process acknowledgement of receipt of the signatures by the users. The acknowledgement module 207 may be configured to resend the signature with a request for acknowledgement when e.g. the user does not acknowledge that the he/she has receive the signature on the user device 101, to receive the acknowledgment of receipt of the signature notification, and to recognize that a receipt notification has not been received by the platform. The acknowledgement module 207 will also send a confirmation to the user that a signature has been registered in the system in the case the signature is not generated by the signature generating module 203, but chosen by the user through the user interface.

In one embodiment, when there are B2B2C services involving account and/or billing related functions (e.g., a sponsored data service), the billing entity checking module 209 may be configured to at least check whether a web session, a web address or a combination thereof is sponsored by any entity so the user is not charged for the services, or that the data used is not counted against his/her data plan. This information may be transmitted to the service indicator module 211, which may compile this information with other service indicator information, and transmit the information to the user through the presenting module 213. It is also contemplated that the billing entity checking module 209 is able to transmit the sponsoring entity information directly to the presenting module 213 to be forwarded to the user. The transmission of sponsoring entity information by billing entity checking module 209 and of service indicator information by the service indicator module 211 may occur independently and concurrently.

In one embodiment, the service indicator module 211 may be configured to at least gather, analyze, save, and confirm service indicator information. The service indicator module 211 may be able to compile service indicator information with the billing entity information to be presented to the user via presentation module 213.

In one embodiment, the presentation module 213 may be configured to present the service indicator and billing entity information in several formats, layouts, etc. The presentation may be presented before, during, or after delivery of the web service. The presentation module 213 is capable of adapting the presentation depending on e.g. whether a link or the signature itself will be presented to the user. In one embodiment, the presentation module 213 interacts with plug-in components embedded in content and/or services delivered to end users by intervening parties (e.g., content providers, enterprises, etc.). For example, the presentation module 213 may respond to queries, get commands, requests, etc. executed by a plug-in (e.g., a JavaScript plug-in) embedded in a content provider's site as part of a B2B2C service. The presentation 213 then transmits the signature and related data to the plugin for delivery and presentation to the user. The presentation of the signature data can be performed during delivery of the service, when a link to initiate the service or view related content is presented, or under any other circumstances that may invoke the associated B2B2C service.

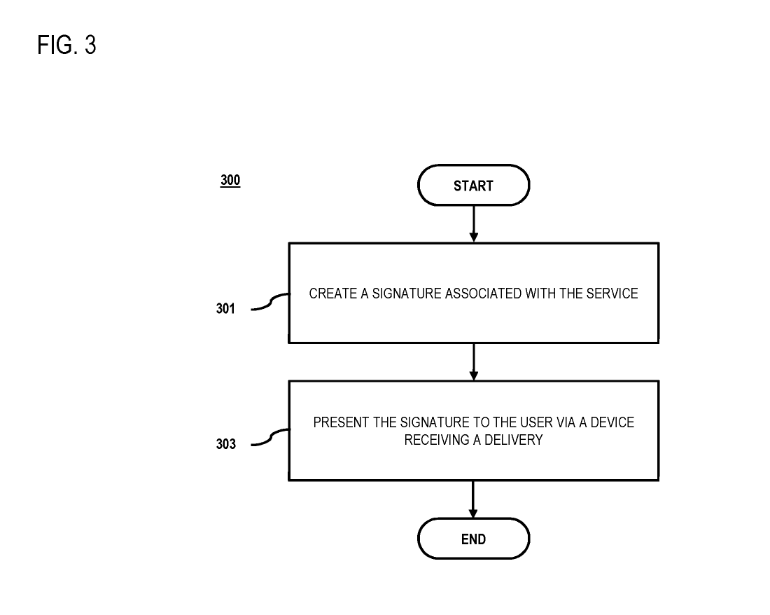

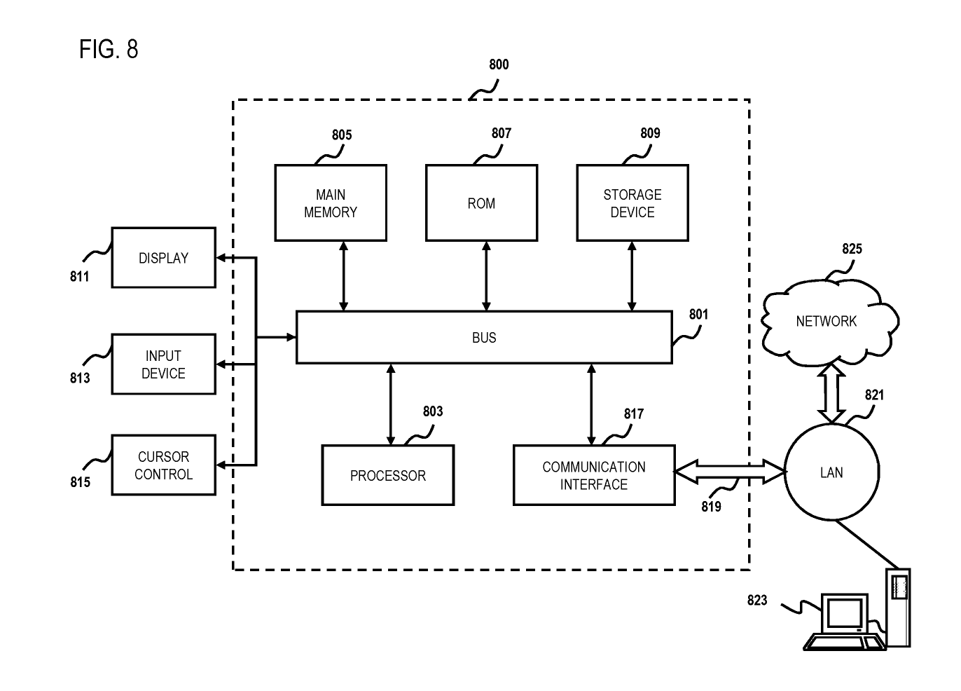

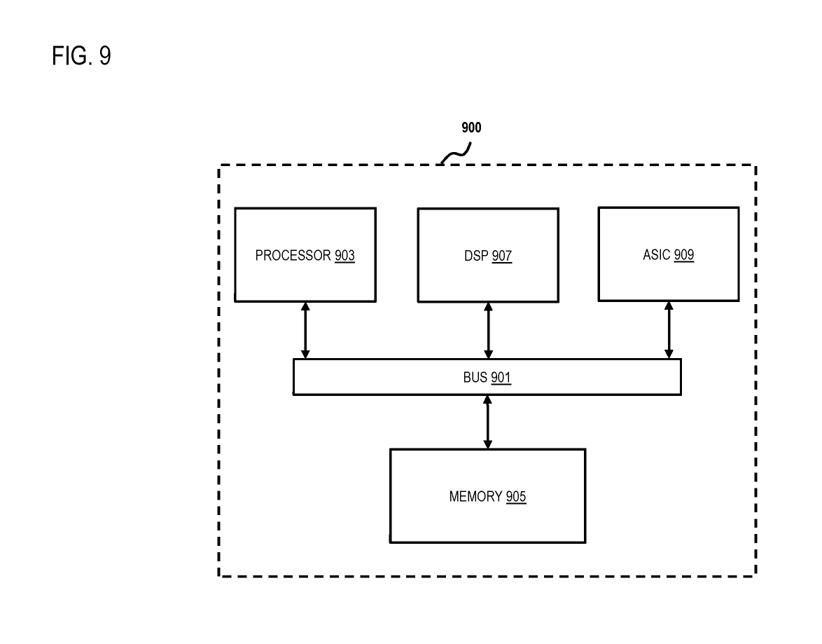

FIG. 3 is a flowchart of processes for providing a secure, user-identifiable service signature, according to one embodiment. In one embodiment, the signature and service platform 115 performs processes 301, and 303, and is implemented in, for instance, a chip set including a processor and a memory as shown in FIGS. 8 and 9.

In step 301 of process 300 (FIG. 3), the signature and service indicator platform 115 creates a signature associated with a service. A service, for instance, is a B2B2C service, as previously discussed, wherein the service originates from an originating service provider, and then is repackaged by one or more intervening parties (e.g., content providers, enterprises, etc.) for delivery to a user (e.g., a customer). For example, the service can be a sponsored data service, wherein a service provider (e.g., a carrier) provides the bandwidth at no cost to the consumer at the request of a content provider (e.g., an e-commerce retailer or other web content provider).

Therefore, in this case, the service relationship can be relatively complex wherein the user has a relationship (e.g., an account) with the carrier (e.g., wireless data services) and with the e-commerce retailer (e.g., a retail account), but not necessarily a single direct relationship with the carrier and the e-commerce retailer as a combined entity. At the same time, the carrier and the content provider may have a relationship (e.g., a contractual agreement) that enables the carrier to redirect charges incurred for bandwidth used by a user to browse the content provider's online data (e.g., a sponsored data service), but without necessarily establishing a separate sponsored data account with the user. So within this potentially complex B2B2C environment, in one embodiment, the service in question is the service (e.g., the sponsored data service) being provided by the service provider (e.g., the carrier) as part of its direct relationship with the user. Therefore, the signature created by the platform 115 is associated with the underlying service that is being performed by the service provider for the user at the request of the content provider.

In one embodiment, the signature can be created at the request of either the service provider or the user. In other embodiments, the content provider can direct the user to contact the service provider to initiate creating the signature. As noted previously, the signature creation process includes personalizing the signature so that the user can recognize the signature when associated services are delivered or proposed to be delivered to the user. Accordingly, the personalized signature can take the form of a visual signature or notification, an audio signature or notification, a haptic signature or notification, a multi-media signature or notification, any combination thereof, or the like.

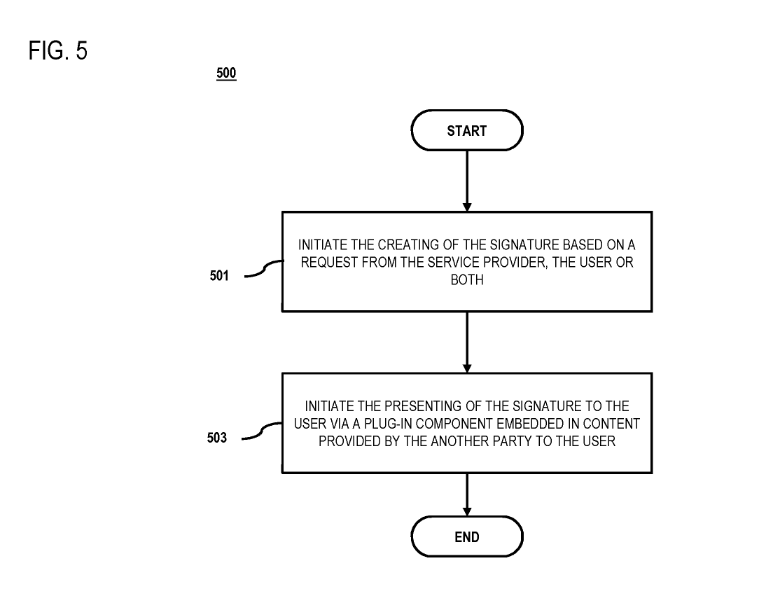

In one embodiment, an input for creating the signature may originate in the user device 101, as per step 501 of FIG. 5, in the platform itself, in the content or online service provider 119, or in any other trusted source. If the signature is created based on a request from the user, he/she might be able to insert his/her personalized signature. When the request for creation originated on the carrier, the signature may be a piece of information personalized to the user, known by the carrier, and unknown by the content provider, enterprise etc. such as the user's phone number, device identifier, date of birth, zip code, etc., or any combination thereof.

In step 303, the signature and service indicator platform 115 presents the signature to the user via the user device. The signature and/or service indicator might be presented during delivering of a service or prior to delivery of the service (by e.g. including the signature beside a link to the service (e.g. a link to a website)). The signature may be presented separately to the service indicator, as part of the delivery of a service indicator, or in conjunction with the service indicator. Alternatively, the signature may be presented via a device that receives a link for initiating the delivery of the signature. For example, a user sees in his/her device that he/she received a link. In one embodiment, the personalized signature and/or service indicator can be presented with the link so that the user can validate the link before engaging the service. In addition or alternatively, it is also contemplated that the signature may be delivered and presented during delivery of the service to the use's device (e.g., by presenting a signature on the display while the service is active).

It is contemplated that the platform 115 may initiate presentation of the signature and/or accompanying service indicator according to different presentation characteristics such as, but not limited to, rendering styles, duration, location, persistence (e.g., whether the signature is displayed always, intermittently, etc.), etc. In addition, the signature can be presented in different forms (e.g., different media) depending on the content being delivered (e.g., audio signature when streaming music over sponsored data service, visual notification during streaming of video over a sponsored data service, etc.).

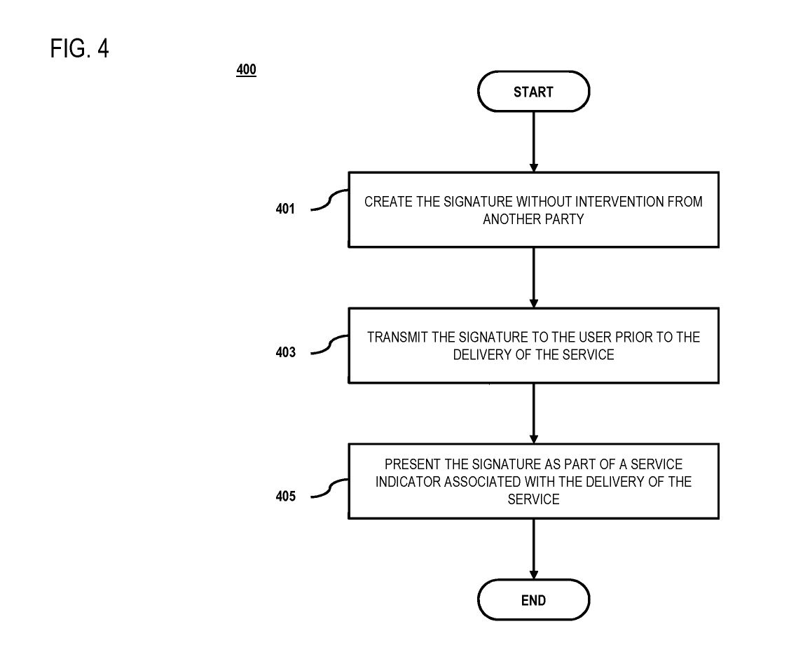

FIG. 4 is a flowchart of processes for providing a secure, user-identifiable service signature and indicators, according to another embodiment. The diagram depicts a creation, transmission of the signature, and presentation of the signature as part of a service indicator service. In one embodiment, the signature and service platform 115 performs processes 401, 403 and 405, and is implemented in, for instance, a chip set including a processor and a memory as shown in FIGS. 8 and 9. More specifically, the service indicator module 211 compiles the service signature with the service indicators, or only the service indicator.

In step 401, the signature may be created after an input or request, e.g., from the user device, automatically by the platform after some triggering event, or after request from a content provider. In one embodiment, the signature may be generated without the intervention of third parties such as a content provider. Therefore, the signature will not be shared with the provider as to prevent the provider from obtaining the user's signature and diminishing the risk of spreading this information and of being discovered by a party that may spoof the service. In some embodiments, where there is a trusted relationship between the originating service provider and another party in a B2B2C environment, the signature may be requested by, and/or shared with the other party (e.g., a content provider).

In step 403, the signature is transmitted to the user prior to the delivery of the service. This allows the user to choose whether to use the services if he/she does not recognize the signature prior to engaging in a purported service to avoid fraudulent outcomes (e.g., incurring fraudulent charges, having a virus implanted in his/her device, or prior to being harmed in any other manner). Accordingly, if the content provider is a third party attempting to mislead the user to think that a certain web address, or service is being, or is about to be, provided by another party, the user will be able to infer that the web address or service is not actually from the party that is purports to be since the signature presented is not the user's unique signature. This is also possible because the platform is capable of checking the service, the service information to be transmitted to the customer by the content provider, and to check whether the content provider is actually the party that it purports to be.

In step 405, the signature is presented to the user as part of a service indicator associated with the delivery of the service. The indicator may be either a static or a dynamic indicator that provides additional information. For example, in an example use case where the B2B2C service is a third-party real-time anti-virus service, the service indicator may be an indication that the user device might get a virus by using the indicated web address or service, that the site is free of viruses/malware, that the provider is untrustworthy, etc. In another example, the service indicator might also be the speed of data transfer, billing and/or sponsoring information, the bandwidth, and the type of content, an advertisement, or any other information associate with the service. It is also contemplated that the service indicator may be presented with the signature or independent from the signature. Additionally, the signature and service indicator may be presented persistently, or in only one or few instants during, before, of after the delivery of the service to the user.

In one embodiment, the service indicator may be based on sponsoring information. For example, sponsoring information may be information regarding whether the service is in fact sponsored by the content provider (content provides pays the carrier for the data utilized by the user). Sponsoring information might also be the extent to which the service is a sponsored data service (i.e. criteria utilized by the content provider), such as the number of times that the user may utilize the service as a sponsored service, the amount of data that the user can utilize the service as a sponsored service, the location that the user needs to be in order to take advantage of the sponsored service, etc.

FIG. 5 is a flowchart of processes for initiating the creating and presenting of the signature for providing a secure, user-identifiable service signature, according to one embodiment. In one embodiment, the signature and service platform 115 performs processes 501, and 503, and is implemented in, for instance, a chip set including a processor and a memory as shown in FIGS. 8 and 9.

In step 501 the signature and service platform 115 initiates the creation of the signature based on the request from the content provider, the user, or both. It is contemplated that initiation or creation of the signature is performed directly by the signature and indicator platform 115.

By way of example, the user might have one signature for several or all services in which he/she engages in. This is possible because the signature as herein described is known by a common party, i.e. the carrier or network service provider. Accordingly, there is no need for the user to have one signature for each content provider in which he/she receives content from. This avoids the necessity of requiring the user to memorize a different signature for each content provider, enterprise, etc., and this might also increase safety of web browsing for the user, as it is not as likely that a user will forget his/her signature, as it would otherwise. Accordingly, if the user only needs to memorize one signature, it is extremely unlikely that the user will ignore the signature presented to him/her. On the other hand, if the user has several signatures, the user might be confused about the specific signature for the specific service being delivered to him/her. For example, a user has one signature for his/her online banking services, another for his/her TV media web channel, etc., if the user is utilizing his/her news media channel, he/she might be confused and think that the signature being shown must be the signature that he is supposed to get when receiving the content from this content provider, but in fact it was an incorrect signature. Alternatively, if the user has one signature for all or several services, the user is unlikely to be confused and think that the signature being shown is the signature that he is supposed to get.

In step 503, the signature is provided via a plug-in component embedded in the content provided by the content provider, enterprise etc. to the user through carrier's network and via the user's device. The content provider, enterprise, etc. does not need to take any different step from the steps that the content provider, enterprise, etc. normally would, which also contributes to the level of security in browsing the web. The level of security may increase because the methods herein described depends only on the carrier (or network service provider) to be implemented, consequently, safety will be assured across the board, as opposed to only a few content providers that provides some time of service certification mechanism.

A previously mentioned, the service might be a sponsored data service for providing content from another party to the user. A sponsored data service is a service in which the content provides pays the carrier for the data utilized by the user. The sponsorship might be based on a number of times that the user utilize the service, a number of times that the user utilize the service within a certain period, amount of data, user location, or any other criteria. The another party may be the content provider, enterprise, etc. that sponsor the data service.

The plug-in component might be a java component, or any other code that if able to run in one platform does not need to be recompiled to run on another platform. A component may be a computer programming language. It is also contemplated that the plugin component might be another computer programming language that is specific to certain platforms.

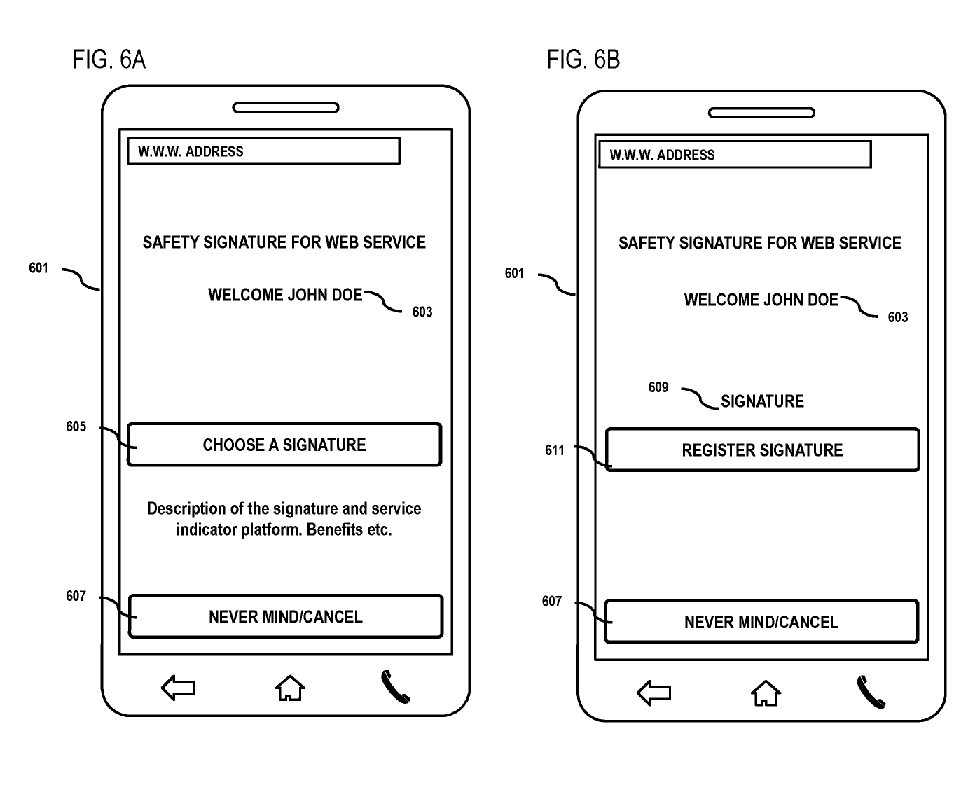

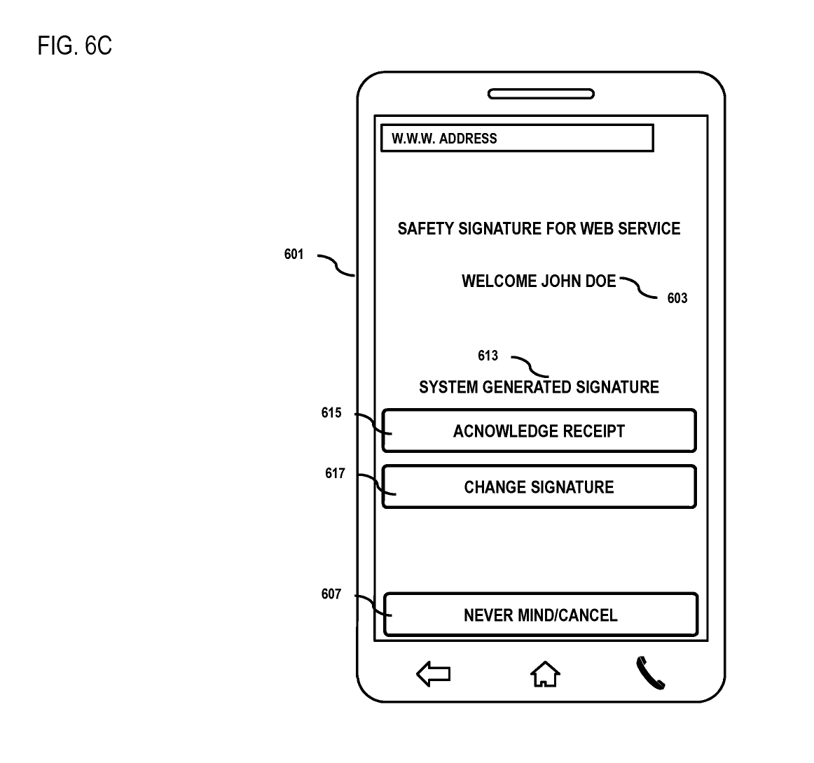

FIGS. 6A-6C are diagrams of user interfaces, according to various embodiments. The diagrams depict an user interface involved in the pre-communication and registration of the user's signature. FIGS. 6A-6B depict a command line interface involved in the insertion of a signature chosen by the user, and FIG. 6C shows a pre-communication of a system generated signature to the user. For the purpose of illustration, the pre-communication may be pushed by the signature and service indicator platform 115 to the user device 101 or requested by the user or content provider, enterprise etc. By way of example, FIGS. 6A-6C includes a smartphone 601, greetings 603 identifying the recipient, an option for choosing a signature 605, an option to cancel 607, a field to insert a signature 609, an option to register signature 611, a filed for presenting the system generated signature 613, an option to acknowledge receipt of the system generated signature 615, and an option to change the signature 617.

Although various embodiments are described with respect to user interface in a smartphone 601, it is contemplated that the user interface may be presented in any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. In addition, the user device 101 may execute different operating systems (OS).

Furthermore, despite that the various embodiments are described with respect to web interface, it is contemplated that the interface may be presented to the user as an application interface, in which case the application may be installed at the user device 101.

FIGS. 6A and 6B illustrate embodiments of user interfaces in which the user is capable of choosing his/her own signature. The user may press choose signature 605 in order to be presented with an option to insert his/her signature 609 (FIG. 6B). Once the user presses chose signature 605, the user is able to insert his signature 609, and, subsequently, touch register signature 611 for registering the signature in the system. This information may be received by signature service indicator platform 115 for processing or registration. The user may be able to type, copy and paste (e.g. if and image as signature), etc. It is contemplated that the user may choose a vibration, or any other type of signal as his/her own signature (not shown here). In case the user gives up choosing his/her own signature, the user may press or touch never mind/cancel 607. It is contemplated that once the never mind/cancel 607 is pressed or touched, a system generated signature may be presented to the user FIG. 6C by the user device 101.

FIG. 6C depicts a user interface for pre-communication of the personalized, user-identifiable signature of a user. The signature and service indicator platform 115, may generate the signature and communicate this to the user as a system generated signature 613. Once the user is presented with the system generated signature 613, the user may actively press acknowledge receipt 615, so the system may stop sending messages to the user device 101 for assuring that the user is aware of his/her signature. Alternatively, the user may press change signature 617 in order to be able to insert his/her signature as shown and described in FIG. 6B. It is contemplated that the option of changing the signature 617 may be presented to the user in case the user wishes to alter a signature previously chosen by the user.

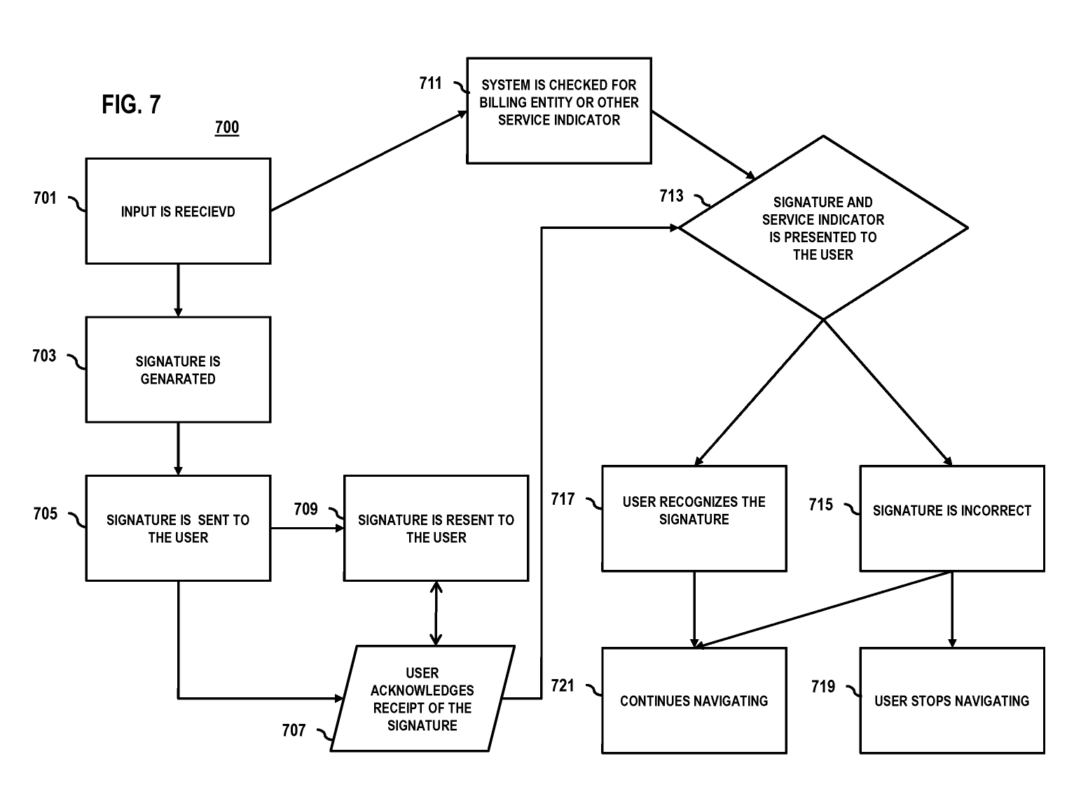

FIG. 7 is a diagram of events involving of a system for providing a secure, user-identifiable service signature, according to one embodiment. In step 701 the signature and service platform 115 receives an input for generating a personalized signature at step 703. The input can be sent when the user initiates a web session, when the user actively requests for a signature, when the user request delivery of a service, or any other method. As soon as the input for generating the signature is received, the system may start checking for billing entities or other services indicators at step 711, in order to immediately inform the user as to whether his/her data will be consumed by the service or to inform of any characteristic/information regarding the service. Accordingly, step 711 may be performed concurrently with steps 703, 705, 707, and 709.

In step 705, the unique signature generated at step 703 is sent to the user for acknowledgment. At this point, the user will be inform of his personalized end user identifiable service signature, or will receive a confirmation that the personalized end user identifiable service signature inserted by the user through his/her user device 101 (and though a user interface) was added/registered to the system and is now active. At step 707, the user acknowledges receipt of the signature so the signature and service indicator platform 115 recognizes that the signature does not need to be resent to the user device 101. If a signature was inserted by the user and was added/registered to the system, the user still might need to acknowledge the message from the system informing that his/her signature is now active. In case the user does not acknowledge receipt of the signature, the signature may be resent to the user in step 709. It is contemplated that step 709 may be performed concurrently with steps 711, 713, 719, and 721.

In step 713, the signature is already active and the user may already know his/her signature. At this point, the information regarding billing entity or other service indicator retrieved in step 711 may be joined by the signature information and presented to the user. At this step, the user may be e.g. browsing on the web or receiving data and the signature is presented. The signature and/or service indicators may be presented in several steps of the service, e.g. only during the service, or only immediately prior to beginning of the service. It is also contemplated that the signature may be presented prior or in the beginning of the service, while the service indicators may be presented at other stages of the services, or that the signature may be presented prior or in the beginning of the service with some indicators, while other indicators are presented in other stages of the service, or any possible combination.

At step 715, the user may perceive that the signature presented is not his signature. The service indicator may also reveal e.g. that the service should not be trusted, or any other information. The service indicator may not show the service as worth of trust, and might provide the reasons that the service is not trustworthy such as because an antivirus has not been run for that service.

The user may choose to continue browsing, step 721, or to stop navigating 719. Alternatively, if the user recognizes the signature, step 717, he/she might just continue navigating.

FIG. 8 is a diagram of a computer system that can be used to implement various exemplary embodiments. The computer system 800 includes a bus 801 or other communication mechanism for communicating information and one or more processors (of which one is shown) 803 coupled to the bus 801 for processing information. The computer system 800 also includes main memory 805, such as a random access memory (RAM) or other dynamic storage device, coupled to the bus 801 for storing information and instructions to be executed by the processor 803. Main memory 805 can also be used for storing temporary variables or other intermediate information during execution of instructions by the processor 803. The computer system 800 may further include a read only memory (ROM) 807 or other static storage device coupled to the bus 801 for storing static information and instructions for the processor 803. A storage device 809, such as a magnetic disk or optical disk, is coupled to the bus 801 for persistently storing information and instructions.

The computer system 800 may be coupled via the bus 801 to a display 811, such as a cathode ray tube (CRT), liquid crystal display, active matrix display, or plasma display, for displaying information to a computer user. An input device 813, such as a keyboard including alphanumeric and other keys, is coupled to the bus 801 for communicating information and command selections to the processor 803. Another type of user input device is a cursor control 815, such as a mouse, a trackball, or cursor direction keys, for communicating direction information and command selections to the processor 803 and for adjusting cursor movement on the display 811.

According to an embodiment of the invention, the processes described herein are performed by the computer system 800, in response to the processor 803 executing an arrangement of instructions contained in main memory 805. Such instructions can be read into main memory 805 from another computer-readable medium, such as the storage device 809. Execution of the arrangement of instructions contained in main memory 805 causes the processor 803 to perform the process steps described herein. One or more processors in a multiprocessing arrangement may also be employed to execute the instructions contained in main memory 805. In alternative embodiments, hard-wired circuitry may be used in place of or in combination with software instructions to implement the embodiment of the invention. Thus, embodiments of the invention are not limited to any specific combination of hardware circuitry and software.

The computer system 800 also includes a communication interface 817 coupled to bus 801. The communication interface 817 provides a two-way data communication coupling to a network link 819 connected to a local network 821. For example, the communication interface 817 may be a digital subscriber line (DSL) card or modem, an integrated services digital network (ISDN) card, a cable modem, a telephone modem, or any other communication interface to provide a data communication connection to a corresponding type of communication line. As another example, communication interface 817 may be a local area network (LAN) card (e.g. for Ethernet™ or an Asynchronous Transfer Model (ATM) network) to provide a data communication connection to a compatible LAN. Wireless links can also be implemented. In any such implementation, communication interface 817 sends and receives electrical, electromagnetic, or optical signals that carry digital data streams representing various types of information. Further, the communication interface 817 can include peripheral interface devices, such as a Universal Serial Bus (USB) interface, a PCMCIA (Personal Computer Memory Card International Association) interface, etc. Although a single communication interface 817 is depicted in FIGS. 4A-4I, multiple communication interfaces can also be employed.

The network link 819 typically provides data communication through one or more networks to other data devices. For example, the network link 819 may provide a connection through local network 821 to a host computer 823, which has connectivity to a network 825 (e.g. a wide area network (WAN) or the global packet data communication network now commonly referred to as the “Internet”) or to data equipment operated by a service provider. The local network 821 and the network 825 both use electrical, electromagnetic, or optical signals to convey information and instructions. The signals through the various networks and the signals on the network link 819 and through the communication interface 817, which communicate digital data with the computer system 800, are exemplary forms of carrier waves bearing the information and instructions.

The computer system 800 can send messages and receive data, including program code, through the network(s), the network link 819, and the communication interface 817. In the Internet example, a server (not shown) might transmit requested code belonging to an application program for implementing an embodiment of the invention through the network 825, the local network 821 and the communication interface 817. The processor 803 may execute the transmitted code while being received and/or store the code in the storage device 809, or other non-volatile storage for later execution. In this manner, the computer system 800 may obtain application code in the form of a carrier wave.

The term “computer-readable medium” as used herein refers to any medium that participates in providing instructions to the processor 803 for execution. Such a medium may take many forms, including but not limited to computer-readable storage medium ((or non-transitory)—i.e., non-volatile media and volatile media), and transmission media. Non-volatile media include, for example, optical or magnetic disks, such as the storage device 809. Volatile media include dynamic memory, such as main memory 805. Transmission media include coaxial cables, copper wire and fiber optics, including the wires that comprise the bus 801. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

FIG. 9 illustrates a chip set or chip 900 upon which an embodiment of the invention may be implemented. Chip set 900 is programmed to deliver messages to a user based on their activity status as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of enabling the transmission of files independent of a file transfer application or the throughput capabilities of the sending or receiving devices.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to deliver messages to a user based on their activity status. The memory 905 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
creating a signature associated with a service, wherein the service is provided by a service provider to a user in conjunction with another party, and wherein the signature is personalized to the user; and
presenting the signature to the user via a device receiving a delivery, a link for initiating the delivery, or a combination thereof of the service to the user.

2. A method of claim 1, further comprising:
transmitting the signature to the device prior to the delivery of the service, a presentation of the link for initiating the delivery of the service, or a combination thereof.

3. A method of claim 1, further comprising:
presenting the signature as part of a service indicator associated with the delivery of the service, the link for initiating the delivery of the service, or a combination thereof.

4. A method of claim 1, further comprising:
creating the signature without intervention from the another party.

5. A method of claim 1, further comprising:
initiating the creating of the signature based on a request from the service provider, the user, or a combination thereof.

6. A method of claim 1, further comprising:
initiating the presenting of the signature to the user via a plug-in component embedded in content provided by the another party to the user,

7. A method of claim 1, wherein the service includes a sponsored data service for providing content from the another party to the user.

8. A method of claim 7, wherein the signature is presented to the user when the sponsored data service is used or proposed to be used for providing the content from the another party to the user.

9. An apparatus comprising a processor configured to:
create a signature associated with a service, wherein the service is provided by a service provider to a user in conjunction with another party, and wherein the signature is personalized to the user; and
present the signature to the user via a device receiving a delivery, a link for initiating the delivery, or a combination thereof of the service to the user.

10. An apparatus according to claim 9, wherein the processor is further configured to:
transmit the signature to the device prior to the delivery of the service, a presentation of the link for initiating the delivery of the service, or a combination thereof.

11. An apparatus according to claim 9, wherein the processor is further configured to:
present the signature as part of a service indicator associated with the delivery of the service, the link for initiating the delivery of the service, or a combination thereof.

12. An apparatus according to claim 9, wherein the processor is further configured to:
create the signature without intervention from the another party.

13. An apparatus according to claim 9, wherein the processor is further configured to:
initiate the creating of the signature based on a request from the service provider, the user, or a combination thereof.

14. An apparatus according to claim 9, wherein the processor is further configured to:
initiate the presenting of the signature to the user via a plug-in component embedded in content provided by the another party to the user.

15. An apparatus of claim 9, wherein the service includes a sponsored data service for providing content from the another party to the user.

16. An apparatus of claim 15, wherein the signature is presented to the user when the sponsored data service is used or proposed to be used for providing the content from the another party to the user.

17. A system comprising a platform configured to:
create a signature associated with a service, wherein the service is provided by a service provider to a user in conjunction with another party, and wherein the signature is personalized to the user; and
present the signature to the user via a device receiving a delivery, a link for initiating the delivery, or a combination thereof of the service to the user.

18. A system of claim 17, wherein the platform is further configured to:
transmit the signature to the user prior to the delivery of the service, a presentation of the link for initiating the delivery of the service, or a combination thereof.

19. A system of claim 17, wherein the platform is further configured to:
present the signature as part of a service indicator associated with the delivery of the service, the link for initiating the delivery of the service, or a combination thereof.

20. A system of claim 17, wherein the platform is further configured to:
create the signature without intervention from the another party.
